(19) United States
(12) Patent Application Publication
(10) Pub. No.: US 2017/0044811 A1
(43) Pub. Date: Feb. 16, 2017

(54) TIGHTLY CLOSED STRUCTURE OF GLASS DOOR

(71) Applicant: Kun -Cheng TSOU, Zhubei City, Hsinchu County (TW)

(72) Inventors: Kun-Cheng TSOU, Zhubei City, Hsinchu County (TW); Ching-Han KAO, Zhubei City, Hsinchu County (TW); Heng-Yi LIN, Zhubei City, Hsinchu County (TW); Ping-Tzu HO, Zhubei City, Hsinchu County (TW)

(21) Appl. No.: 15/306,278

(22) PCT Filed: Apr. 25, 2014
(86) PCT No.: PCT/CN2014/076186

§ 371 Date: Oct. 24, 2016

(51) Int. Cl. E05D 15/26; E06B 3/02; E06B 3/48; E06B 3/70

(52) U.S. Cl. CPC E05D 15/26; E06B 3/70; E06B 3/02; E06B 3/481; E06B 2003/7059; E06B 2003/7046

(57) ABSTRACT

A tightly closed structure of a glass door comprises a doorframe and a first door panel. An upper containing groove is transversely arranged at the top of the doorframe and a lower containing groove is transversely arranged at the bottom of the doorframe. An upper frame strip and a lower frame strip that protruding from the first door panel are respectively arranged on the upper edge and the lower edge at the direction which the first door panel faces to the doorframe. The upper frame strip is embedded in the upper containing groove and the lower frame strip is embedded in the lower containing groove. When the first door panel and the doorframe are fastened, the upper frame strip and the lower frame strip are fastened into the upper containing groove and the lower containing groove at the same time, so that the upper frame strip and the lower frame strip can be hidden and make the first door panel and the doorframe to be tightly closed.

### BACKGROUND

Technical Field

The present invention relates to a door panel, and more particularly, to a door structure that can be tightly closed within a doorframe and produce a sealing effect.

Related Art

Most of modern shops, stores and department stores tend to use glass doors, glass walls and windows as their facade, reasons behind such choice is that, by the light-transmissive glass, merchandise and furnishings inside the buildings can be directly viewed from the outside, there are visual effects of clean, bright, and transparent, vision is wide, everything is seen at a glance and thus, glass plates are gradually selected as an outer wall of buildings or as a wall-surface of compartments.

However, glass doors are not suitable to be drilled for installing connecting components such as hinges, pivots, handles, etc., so tempered glass doors are pivoted on doorframes, as seen in FIG. 1, a metal clip frame 2 is installed in advance respectively on upper and lower sides of a glass door 1, the metal clip frame 2 on the upper side is pivotally connected to an upper frame 5 of a doorframe 4 by a pivot 3 and the metal clip frame 2 on the lower side, by another pivot 3, is pivotally connected to a lower frame 6 of the doorframe 4, so that the glass door 1 can be rotated to be open and shut. The more traditional glass doors are even fringed with a metal frame to enable easy drilling for installing door handles and pivots, and then the glass door can be further pivotally connected to the doorframe.

However, such glass door fringed with metal frame, the metal frame will obstruct the sight, causing aesthetic problems. In particular, for multi-faceted foldable glass doors being gathered and spread, when every piece of the glass door is surrounded with a metal frame, not only the sight is impeded, the see-through property and no barrier function of glass will also be effected. Moreover, many stores or shops use multi-plated folding glass doors assembled with a large doorframe, when folded back, the door panels are stacked at a side of the doorframe to be open, and when spread out, the door panels are transversely aligned to be framed as shut, but in the existing folding glass doors, between the adjacent left and right panels, there is no air-tight facilities to block noise and dust from entering the room and what's important is that the temperature indoor cannot be maintained at an appropriate range, resulting in leakage of cold air/heat or entry of cold air/heat outdoor into the room.

### SUMMARY

The main object of the present invention is to solve the problems of the existing glass doors, such as the metal-clip frames will hinder sight, and unable to render neat and brightness over the entire surface of the glass door.

Another object of the present invention is to solve the problem of the existing folding glass doors, wherein an effect of air-tight effect cannot be achieved and leakage indoors and entry outdoors of cold air/heat.

To achieve the above objects, the present invention provides a tightly closed structure of a glass door, comprising a doorframe and a first door panel, wherein: an upper containing groove is transversely arranged at the top of the doorframe and a lower containing groove is transversely arranged at the bottom of the doorframe, an upper frame strip and a lower frame strip that protruding from the first door panel are respectively arranged on the upper edge and the lower edge at the direction which the first door panel faces to the doorframe, and the upper frame strip is embedded in the upper containing groove and the lower frame strip is embedded in the lower containing groove.

Wherein, the upper frame strip and the lower frame strip are respectively provided with vertical upper and lower pivots, the doorframe, at upper and lower sides thereof, are provided respectively with upper and lower shaft holes and the upper shaft hole fits with the upper pivot and the lower shaft hole fits with the lower pivot.

Wherein, the doorframe is large and grouped with the first door panel and a second door panel pivotally connected to the first door panel, and an upper frame strip and a lower frame strip that protruding from the second door panel are respectively arranged on the upper edge and the lower edge at the direction which the second door panel faces to the doorframe, the upper containing groove of the doorframe is provided for embedding the upper frame strip of the second door panel and the lower containing groove of the doorframe is provided for embedding the lower frame strip of the second door panel.

Wherein, one of the left and right sides of the first door panel is provided with a vertical first side frame strip, thickness of the first side frame strip corresponds to that of the first door panel such that a first inner wall surface of the first door panel facing to the doorframe is sealed firmly to the doorframe, a side of the second door panel is provided with a vertical second side frame strip that cooperates with the first side frame strip, and thickness of the second side frame strip corresponds to that of the second door panel such that a second inner wall surface of the second door panel facing to the doorframe is sealed firmly to the doorframe.

Wherein, the first and second door panels are pivotally connected by at least a first hinge, and a sealing strip parallel to the first and second side frame strips is provided between the first and second side frame strips.

Wherein, the first side frame strip is provided with a recess, the recess has two opposite wall surfaces with the sealing strips provided thereon, and the second side frame strip is provided with a convex strip that is embedded in the recess for compressing the sealing strips.

Wherein, an elastic pad is transversely arranged both on upper and lower edges of the doorframe, and the first wall surface of the first door panel and the second wall surface of the second door panel are in tight contact with the elastic pads of the doorframe.

Wherein, the second door panel is pivotally connected to a third door panel, upper and an lower frame strips are transversely arranged on upper and lower edges of the third door panel facing to the doorframe, the upper and lower frame strips of the third door panels are respectively embedded in the upper and lower containing grooves of the doorframe, another side of the second door panel is provided with a vertical first side frame strip, thickness of the first side frame strip of the second door panel corresponds that of the second door panel such that the second inner wall surface of the second door panel facing to the doorframe is sealed firmly to the doorframe , the third door panel is provided with a second side frame strip that cooperates the first side frame strip of the second door panel, thickness of the second side frame strip of the third door panel correspond to that of the third door panel such that a third inner wall surface of the third door panel facing to the doorframe is sealed firmly to the doorframe.

Wherein, the first side frame strip of the second door panel is provided with a recess, the recess has two opposite wall surfaces with sealing strips provided thereon, and the second side frame strip of the third door panel is provided with a convex strip that is embedded in the recess for compressing the sealing strips.

Wherein, the upper frame strips of the second and third door panels are provided with elastic components that can be stretched axially.

Wherein, between the first and second door panels, a first hinge is respectively provided up and down, the first hinge positioned down is pivotally connected to a caster that rolls on a track above ground, the first hinge positioned up is pivotally connected to a runner that slides on a rail above the doorframe and the second and third door panels are pivotally connected by at least a second hinge.

Thereby, the present invention has at least the following advantages:
1. The upper and lower frame strips of the first door panel are respectively embedded in the upper and lower containing grooves of the doorframe, and the upper and lower frame strips of the second door panel are also respectively embedded in the upper and lower containing grooves of the doorframe, a visual experience of bright and smooth of the first door panel in entire glass material is rendered.
2. With the same thickness of the first and second side frame strips as that of the first, second and the third door panels, the first, second and the door panels are unfolded by the first and second hinges and aligned transversely to completely seal the doorframe, and the first inner wall surface of the first door panel, the second inner wall surface of the second door panel and the third inner wall surface of the third door panels all are pressed close against the elastic pads such that the first, second and third panels are tightly sealed to the upper and lower edges of the doorframe.
3. A sealing strip is provided parallel to and between the first and the second side frame strips such that when the first, second and third door panels are unfolded contiguous to one another and sealed within the doorframe, the convex strip of the second side frame strip is able to be embedded in the recess of the first side frame strip and the convex strip compresses the sealing strip, making air tight between the contiguous first through third door panels and thereby insulating heat, sound and dust.
4. It is worth mentioned that the upper frame strips of the second and third door panels are provided with elastic components that can be stretched axially, and when the second and third door panels are aligned transversely to completely seal the doorframe, the second and third door panels are strained by the elastic force of the elastic components such that the convex strip is compressed against the sealing strips and thereby the air tight effect is ensured.

### BRIEF DESCRIPTION OF THE DRAWINGS

The disclosure will become more fully understood from the detailed description given herein below for illustration only, and thus are not limitative of the disclosure, and wherein:

FIG. 1 is a perspective view of a conventional glass door and doorframe.

FIG. 2 is a schematic perspective view of a first embodiment in the present application.

FIG. 3 is a cross-sectional schematic view of the first embodiment in the present application.

FIG. 4 is a perspective schematic view of assembly of first and second door panels and a doorframe of a second embodiment in the present application.

FIG. 5 is a schematic plan view of the second embodiment in the present application.

FIG. 6 is a perspective view of the assembly of first and second door panels of the second embodiment in the present application.

FIG. 7A is a mechanical schematic view (I) of the second embodiment.

FIG. 7B, is a mechanical schematic view (II) of the second embodiment.

FIG. 7C is a partially enlarged view of FIG. 7B.

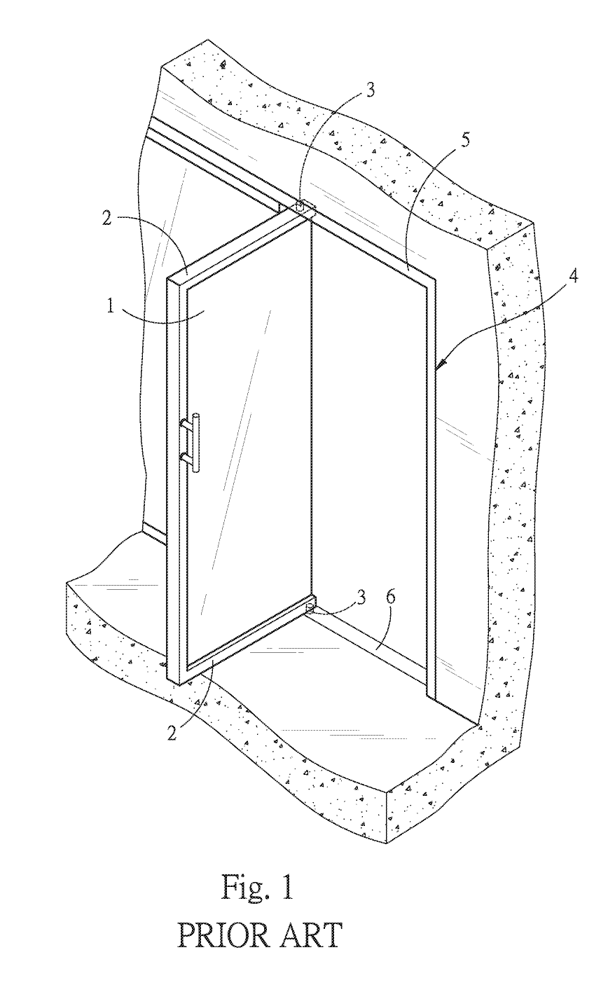

### DETAILED DESCRIPTION

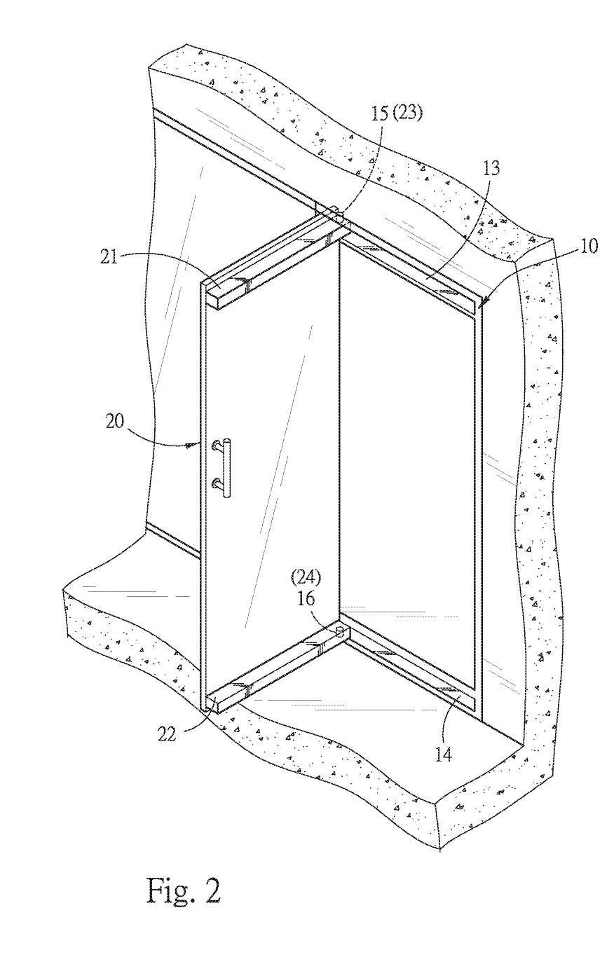

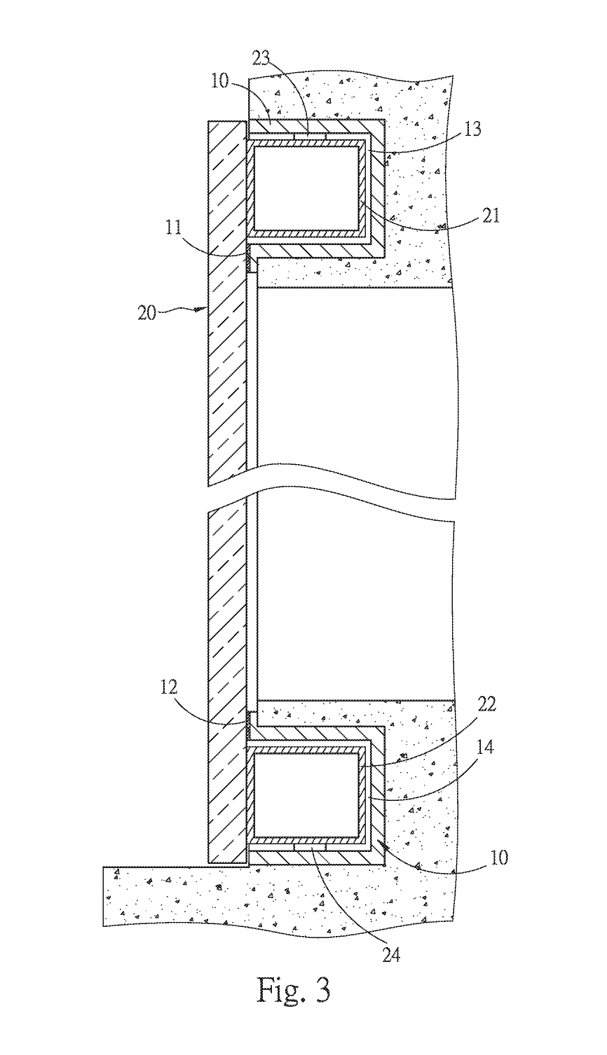

See FIGS. 2 and 3, FIG. 2 is a schematic perspective view of a first embodiment in the present application, and FIG. 3 is a cross-sectional schematic view thereof. The present application discloses a tightly closed structure of a glass door, comprising a doorframe 10 and a first door panel 20 made of glass and pivotally connected to the doorframe 10, an upper containing groove 13 is transversely arranged at the top of the doorframe 10 and a lower containing groove 14 is transversely arranged at the bottom of the doorframe 10, and at upper and lower sides of the doorframe 10 are provided respectively with upper and lower shaft holes 15, 16. An upper frame strip 21 and a lower frame strip 22 that protruding from the first door panel 20 are respectively arranged on the upper edge and the lower edge at the direction which the first door panel 20 faces to the doorframe 10, the upper frame strip 21 is embedded in the upper containing groove 13 and the lower frame strip 22 is embedded in the lower containing groove 14, the upper frame strip 21 and the lower frame strip 22 are respectively provided with vertical upper and lower pivots 23, 24, and the upper shaft hole 15 fits with the upper pivot 23 and the lower shaft hole 16 fits with the lower pivot 24.

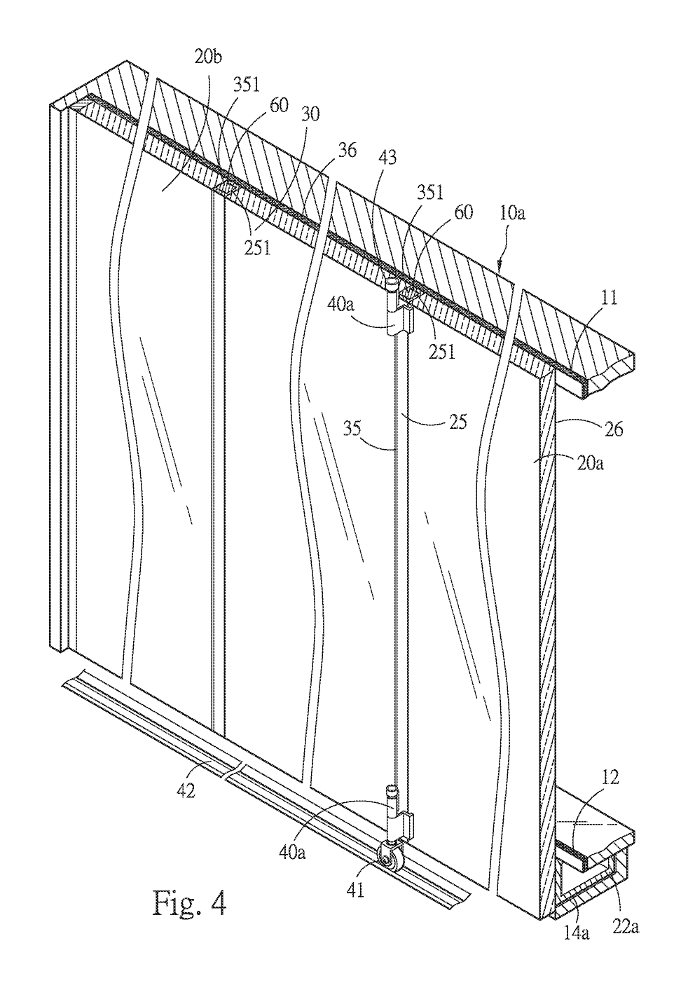

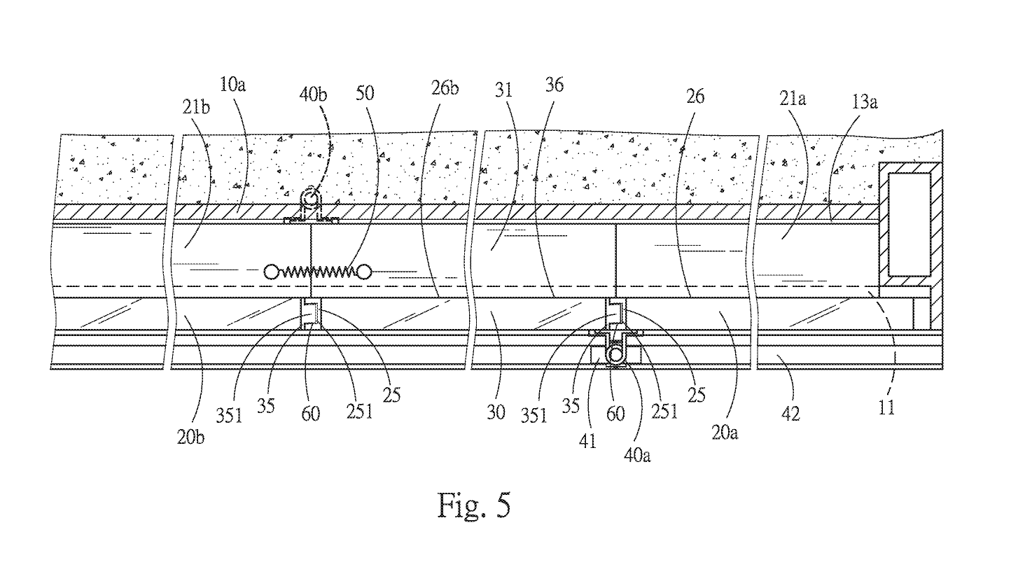

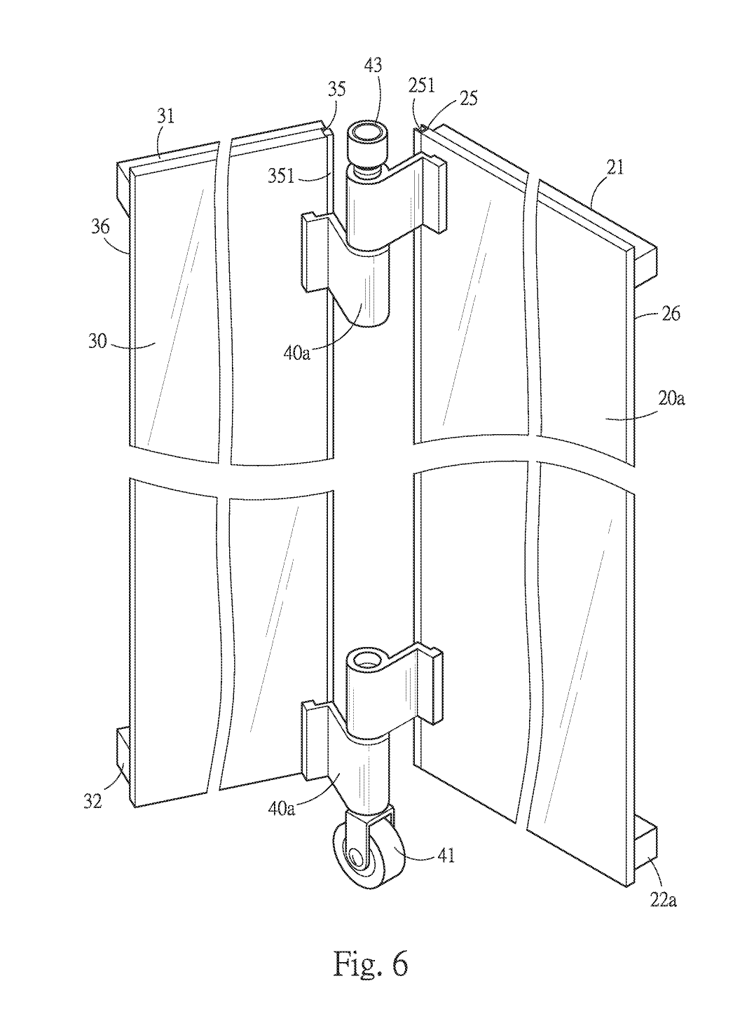

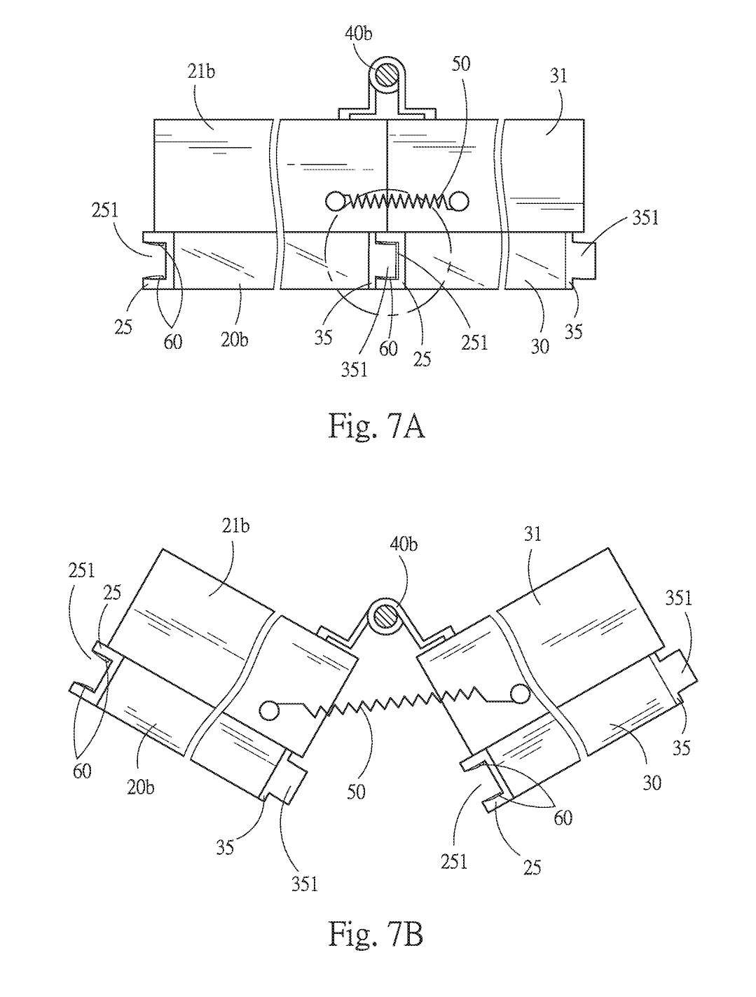

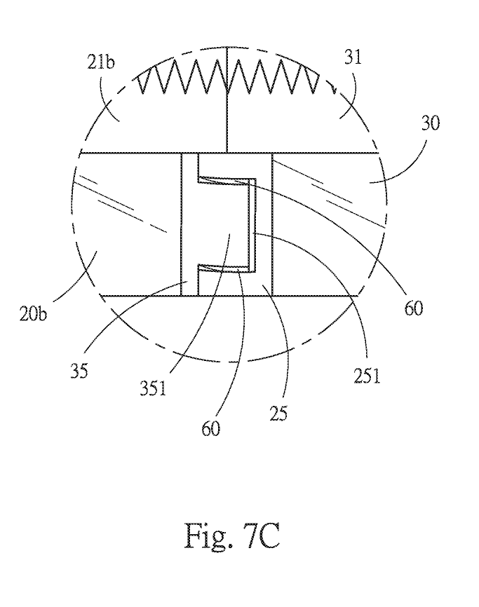

Please also refer to FIG. 4, FIG. 5, FIG. 6 and FIG. 7A. FIG. 4 is a perspective schematic view of assembly of first and second door panels and a doorframe of a second embodiment, FIG. 5 is a schematic plan view of the second embodiment, FIG. 6 is a perspective view of the assembly of first and second door panels of the second embodiment and FIG. 7A is a mechanical schematic view (I) of the second embodiment. The present invention is to seal a large doorframe 10a, wherein: the doorframe 10a is transversely provided with an elastic pad 11, 12 respectively on upper and lower edges thereof, and assembled with a first door panel 20a, a second door panel 30 and a third door panel 20b, the second door panel 30 is pivotally connected to the first door panel 20a and the third door panel 20b is pivotally connected to the second door panel 30, the door panels 20a, 30 and 20b may be made of glass material, the first and second door panels 20a, 30 are pivotally connected by at least a first hinge 40a, and in the present embodiment, between the first and second door panels 20a, 30, the first hinge 40a is respectively provided up and down, the first hinge 40a positioned down is pivotally connected to a caster 41 that rolls on a track 42 above ground, the first hinge 40a positioned up is pivotally connected to a runner 43 that slides on a rail (not shown) above the doorframe 10a such that the first and second door panels 20a, 30, by the first hinge 40a, can be folded back to the side and spread out aligned and sealed within the doorframe 10a to be shut.

The second and third door panels 30, 20b are pivotally connected by at least a second hinge 40b, and in the present embodiment, between the second and third door panels 30, 20b, the second hinge 40b is respectively provided up and down such that the second and third door panels 30, 20b, by the second hinge 40b, can be folded back to the side and spread out aligned and sealed within the doorframe 10a to be shut.

An upper frame strip 21a, 31, 21b and a lower frame strip 22a, 32 that protruding from the first, second and third door panels 20a, 30, 20b are respectively arranged on the upper edge and the lower edge at the direction which the first, second and third door panels 20a, 30 and 20b face to the doorframe 10a, an upper containing groove 13a of the doorframe 10a is provided for embedding the upper frame strips 21a, 31, 21b of the first, second and third door panels 20a, 30 and 20b respectively and a lower containing groove 14a of the doorframe 10a is provided for embedding the lower frame strips 22a, 32 of the first, second and third door panels 20a, 30, 20b respectively.

In the present embodiment, one of the left and right sides of the first door panel 20a is provided with a vertical first side frame strip 25, thickness of the first side frame strip 25 corresponds to that of the first door panel 20a such that a first inner wall surface 26 of the first door panel 20a facing to the doorframe 10a is sealed firmly to the doorframe, and in the present embodiment, the first side frame strip 25 and the first door panel 20a have a same thickness. A side of the second door panel 30 is provided with a vertical second side frame strip 35 that cooperates with the first side frame strip 25, and thickness of the second side frame strip 35 corresponds to that of the second door panel 30 such that a second inner wall surface 36 of the second door panel 30 facing to the doorframe 10a is sealed firmly to the doorframe 10, and in the present embodiment, the first wall surface 26 of the first door panel 20a and the second wall surface 36 of the second door panel 30 are in tight contact with the elastic pads 11, 12 arranged on upper and lower edges of the doorframe 10a. Thereby, the first and second door panels 20a, 30 are sealed closely to the doorframe 10a and thus prevent cold air/heat from leaking or entering indoor and also achieve the effects of insulating noise and dust.

Please refer to FIG. 5, FIGS. 7A-7C, another side of the second door panel 30 is provided with another vertical first side frame strip 25, thickness of the first side frame strip 25 of the second door panel 30 corresponds that of the second door panel 30 such that the second inner wall surface 36 of the second door panel 30 facing to the doorframe 10a is sealed firmly to the doorframe 10a and in the present embodiment, the first side frame strip 25 of the second door panel 30 and the second door panel 30 have a same thickness such that the second wall surface 36 of the second door panel 30 is in tight contact with the elastic pads 11, 12. The third door panel 20b is provided with the second side frame strip 35 that cooperates the first side frame strip 25 of the second door panel 30, thickness of the second side frame strip 35 of the third door panel 20b correspond to that of the third door panel 20b such that a third inner wall surface 26b of the third door panel 20b facing to the doorframe 10a is sealed firmly to the doorframe 10a and in the present embodiment, the third inner wall surface 26b of the third door panel 20b is in tight contact with the elastic pads 11, 12. Thereby, the upper and lower edges of the first through third door panels 20a, 30, 20b are completely sealed within the doorframe 10a, consequently preventing cold air/heat from leaking or entering and also achieving the effects of insulating noise and dust.

At least a sealing strip 60 is provided parallel to and between the first and the second side frame strips 25, 35, and in the present embodiment, the first side frame strip 25 is provided with a recess 251, the recess 251 has two opposite wall surfaces with sealing strips 60 provided thereon, and the second side frame strip 35 is provided with a convex strip 351 that is embedded in the recess 251 for compressing the sealing strips 60.

Also, the upper frame strips 31, 21b of the second and third door panels 30, 20b are provided with an elastic component 50 that can be stretched axially and the elastic component 50 may be a spring.

Accordingly, when the first, second and third door panels 20a, 30, 20b are spread aligned transversely to be framed within the doorframe 10a as shut, the convex strip 351 of the second side frame strip 35 is right embedded in the recess 251 of the first side frame strip 25, the convex strip 351 compresses the two sealing strips 60 to be airtight.

Additionally, by the elastic force of the elastic component 50, the second and third door panels are strained to be aligned in parallel, and further the convex strip 351 is compressed against the sealing strips 60 and thereby the air tight effect is ensured, and the problem of cold air/heat leaking or entering from outdoor caused by the contiguous door panels 20a, 30 and 20b may be solved.

By the above structure, the present invention has at least the following advantages:
1. The upper and lower frame strips of the first door panel are respectively embedded in the upper and lower containing grooves of the doorframe, and the upper and lower frame strips of the second door panel are also respectively embedded in the upper and lower containing grooves of the doorframe, a visual experience of bright and smooth of the first door panel in entire glass material is rendered.
2. With the same thickness of the first and second side frame strips as that of the first, second and the third door panels, the first, second and the door panels are unfolded by the first and second hinges and aligned transversely to completely seal the doorframe, and the first inner wall surface of the first door panel, the second inner wall surface of the second door panel and the third inner wall surface of the third door panels all are pressed close against the elastic pads such that the first, second and third panels are tightly sealed to the upper and lower edges of the doorframe.
3. A sealing strip is provided parallel to and between the first and the second side frame strips such that when the first, second and third door panels are unfolded contiguous to one another and sealed within the doorframe, the convex strip of the second side frame strip may be able to be embedded in the recess of the first side frame strip and the convex strip compresses the sealing strips, making air tight between the contiguous first through third door panels and thereby insulating heat, sound and dust.
4. It is worth mentioned that the upper frame strips of the second and third door panels are provided with elastic components that can be stretched axially, and when the second and third door panels are aligned transversely to completely seal the doorframe, the second and third door panels are strained by the elastic force of the elastic components such that the convex strip is compressed against the sealing strips and thereby the air tight effect is ensured.

What is claimed is:

1. A tightly closed structure of a glass door, comprising:
a doorframe, the doorframe being transversely provided with an upper containing groove at the top thereof and a lower containing groove transversely provided at the bottom thereof;
a first door panel, an upper frame strip and a lower frame strip protruding from the first door panel and respectively provided on the upper and lower edges thereof at a direction which the first door faces to the doorframe, the upper frame strip being embedded in the upper containing groove and the lower frame strip being embedded in the lower containing groove.

2. The tightly closed structure of the glass door according to claim 1, wherein the upper frame strip and the lower frame strip are respectively provided with vertical upper and lower pivots, the doorframe, at upper and lower sides thereof, are provided respectively with upper and lower shaft holes and the upper shaft hole fits with the upper pivot and the lower shaft hole fits with the lower pivot.

3. The tightly closed structure of the glass door according to claim 1, wherein the doorframe is large and grouped with the first door panel and a second door panel pivotally connected to the first door panel, and an upper frame strip and a lower frame strip that protruding from the second door panel are respectively arranged on the upper and lower edges at the direction which the second door panel faces to the doorframe, the upper containing groove of the doorframe is provided for embedding the upper frame strip of the second door panel and the lower containing groove of the doorframe is provided for embedding the lower frame strip of the second door panel.

4. The tightly closed structure of the glass door according to claim 3, wherein one of the left and right sides of the first door panel is provided with a vertical first side frame strip, thickness of the first side frame strip corresponds to that of the first door panel such that a first inner wall surface of the first door panel facing to the doorframe is sealed firmly to the doorframe, a side of the second door panel is provided with a vertical second side frame strip that cooperates with the first side frame strip, and thickness of the second side frame strip corresponds to that of the second door panel such that a second inner wall surface of the second door panel facing to the doorframe is sealed firmly to the doorframe.

5. The tightly closed structure of the glass door according to claim 4, wherein the first and second door panels are pivotally connected by at least a first hinge, and a sealing strip is provided parallel to and between the first and second side frame strips.

6. The tightly closed structure of the glass door according to claim 5, wherein the first side frame strip is provided with a recess, the recess has two opposite wall surfaces with the sealing strips provided thereon, and the second side frame strip is provided with a convex strip that is embedded in the recess for compressing the sealing strips.

7. The tightly closed structure of the glass door according to claim 4, wherein an elastic pad is transversely arranged both on upper and lower edges of the doorframe, and the first wall surface of the first door panel and the second wall surface of the second door panel are in tight contact with the elastic pads of the doorframe.

8. The tightly closed structure of the glass door according to claim 3, wherein the second door panel is pivotally connected to a third door panel, upper and lower frame strips are transversely arranged on upper and lower edges of the third door panel facing to the doorframe, the upper and lower frame strips of the third door panels are respectively embedded in the upper and lower containing grooves of the doorframe, another side of the second door panel is provided with a vertical first side frame strip, thickness of the first side frame strip of the second door panel corresponds that of the second door panel such that a second inner wall surface of the second door panel facing to the doorframe is sealed firmly to the doorframe, the third door panel is provided with a second side frame strip that cooperates the first side frame strip of the second door panel, thickness of the second side frame strip of the third door panel correspond to that of the third door panel such that a third inner wall surface of the third door panel facing to the doorframe is sealed firmly to the doorframe.

9. The tightly closed structure of the glass door according to claim 8, wherein he first side frame strip of the second door panel is provided with a recess, the recess has two opposite wall surfaces with sealing strips provided thereon, and the second side frame strip of the third door panel is provided with a convex strip that is embedded in the recess for compressing the sealing strips.

10. The tightly closed structure of the glass door according to claim 8, wherein the upper frame strips of the second and third door panels are provided with elastic components that can be stretched axially.

11. The tightly closed structure of the glass door according to claim 8, wherein, between the first and second door panels, a first hinge is respectively provided up and down, the first hinge positioned down is pivotally connected to a caster that rolls on a track above ground, the first hinge positioned up is pivotally connected to a runner that slides on a rail above the doorframe and the second and third door panels are pivotally connected by at least a second hinge.
